(19) United States
(12) Patent Application Publication
(10) Pub. No.: US 2018/0349594 A1
(43) Pub. Date: Dec. 6, 2018

(54) TWO-CHANNEL BASED AUTHENTICATION METHOD AND SYSTEM

(71) Applicant: BARO SERVICE CO.,LTD., Seoul (KR)

(72) Inventors: Jae Young JUNG, Seoul (KR); Yong Woo JEONG, Seoul (KR)

(73) Assignee: BARO SERVICE CO.,LTD., Seoul (KR)

(21) Appl. No.: 15/772,069

(22) PCT Filed: Oct. 28, 2016
(86) PCT No.: PCT/KR2016/012228

§ 371 Date: Apr. 29, 2018

(30) Foreign Application Priority Data
Oct. 30, 2015 (KR) 10-2015-0152066

(51) Int. Cl. G06F 21/42; G06F 21/34

(52) U.S. Cl. CPC G06F 21/42; G06F 21/34

(57) ABSTRACT

According to an embodiment, a computer-implemented two-channel based authentication method is disclosed, which is implemented by a computer in a two-channel based authentication system including a computer of an authentication requester, a telephone of the authentication requester, an authentication server, and a call processing server.

### TECHNICAL FIELD

The present invention relates to a two-channel based authentication method and system enabling a user to obtain authentication in a safe manner by using only the user's identification information such as a user ID, which is input on the computer.

### RELATED ART

In general, people log in to a website by inputting user IDs and passwords to receive services. However, at a time when any computer systems can be hacked, inputting both user IDs and passwords on the computer increases the risk of personal information leakage.

### DETAILED DESCRIPTION OF THE INVENTION

### Technical Problems

According to an embodiment of the present invention, provided is an authentication method and system enabling a user to obtain authentication in a safe manner by using only the user's identification information such as a user ID without using a password.

### Technical Solutions

According to an embodiment of the present invention, provided is a computer-implemented two-channel based authentication method which is implemented by a computer in a two-channel based authentication system including a computer of an authentication requester, a telephone of the authentication requester, an authentication server, and a call processing server, including: a displaying step in which the computer of the authentication requester displays an authentication-request screen for requesting authentication—a screen that includes menus for inputting the authentication requester's identification information and for requesting authentication; a first transmitting step in which the computer of the authentication requester transmits a request for authentication to the authentication server when receiving the request for authentication from the authentication requester on the authentication-request screen; a storing step in which the authentication server stores a telephone number of the authentication requester in a temporary DB when receiving the request for authentication; a line number selecting step in which the authentication server selects any one of line numbers available for calling; a second transmitting step in which the authentication server transmits the line number selected in the line number selecting step to the telephone of the authentication requester; a calling step in which the telephone of the authentication requester calls at the line number transmitted by the authentication server; a third transmitting step in which the call processing server transmits to the authentication server the telephone number of the telephone calling at the selected line number when receiving the call at the selected line number; a comparing step in which the authentication server compares the telephone number transmitted by the call processing server with the telephone number of the authentication requester stored in the temporary DB; and a determining step in which the authentication server determines to authorize the request for authentication from the computer of the authentication requester, if the telephone number transmitted by the call processing server is the same as the telephone number of the authentication requester stored in the temporary DB as a result of the comparison in the comparing step.

According to another embodiment of the present invention, provided is a two-channel based authentication system including a computer of an authentication requester, a telephone of the authentication requester, an authentication server, and a call processing server, in which the computer of the authentication requester displays an authentication-request screen for requesting authentication—a screen that includes menus for inputting the authentication requester's identification information and for requesting authentication, the computer of the authentication requester transmit a request for authentication to the authentication server when receiving the request for authentication from the authentication requester on the authentication-request screen, the authentication server selects any one of line numbers available for calling and transmits the selected line number to the telephone of the authentication requester, the telephone of the authentication requester calls at the line number transmitted by the authentication server, the call processing server transmits to the authentication server the telephone number of the telephone calling at the selected line number when receiving the call at the selected line number, and the authentication server compares the telephone number transmitted by the call processing server with the telephone number of the authentication requester, determines the telephone number transmitted by the call processing server is the same as the telephone number of the authentication requester and then, determines to authorize the request for authentication from the computer of the authentication requester.

### Advantageous Effects

According to one or more embodiments of the present invention, a user may obtain authentication in a safe manner by inputting only the user's identification information such as a user ID without inputting a password.

### BRIEF DESCRIPTION OF THE INVENTION

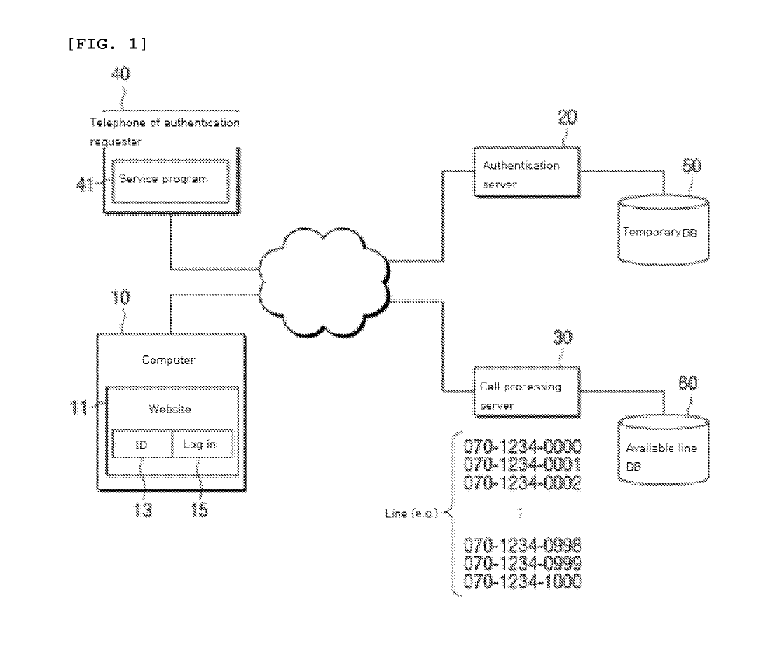

FIG. 1 is a view illustrating a two-channel based authentication system according to an embodiment of the present invention.

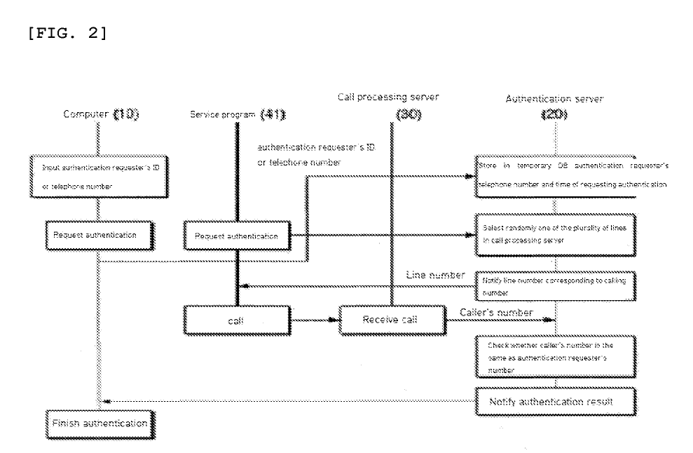

FIGS. 2 to 7 are views illustrating various embodiments of the two-channel based authentication system in FIG. 1.

### DESCRIPTION OF SYMBOLS

10: Computer
11: Website
13: ID input part
15: Login menu
20: Authentication server
30: Call processing server
40: Telephone
41: Service program
50: Authentication DB

### BEST MODE FOR CARRYING OUT THE INVENTION

Objects, other objects, features and advantages of the present invention will be easily understood on the basis of the description of the preferred embodiments that will be described hereunder in relation to the attached drawings. The invention, however, may be embodied in various different forms and should not be construed as being limited only to the illustrated embodiments. Rather, these embodiments are provided as examples so that this disclosure will be thorough and complete and that the technical ideas of the present invention will be fully conveyed to those skilled in the art.

In this specification, it is to be understood that an element described as on another element means an element directly is formed on another element, or a third element may intervene between one element and another element. Meanwhile, terms such as “part”, “device”, “module” etc. set forth in this specification denote units in which at least one function or operation is carried out and may be embodied through hardware or software or a combination of hardware and software.

Throughout the specification, the wording of “transmit”, “communicate”, “send”, “receive”, “provide”, or “deliver” signals, data or information and “the like with similar meanings thereof” means that one element (“element A”) directly delivers signals, data or information to another element (“element B”) and also means that one delivers signals, data or information to another element through one or more third elements (“element C”).

In this specification, it is to be understood that elements “relevant to each other in operation” are connected in a wired and/or wireless manner so as to send and/or receive data between the elements. Meanwhile, in this specification, even though the wording that one element (“element A”) and another element (“element B”) are relevant to each other in operation is not explicitly stated, it should be understood that element A and element B are “relevant to each other in operation” when element A performs functions thereof (element A) by receiving signals, data or information output by element B, or element B performs functions thereof (element B) by receiving signals, data or information output by element A.

In this specification, for instance, communication networks may consist of Wi-Fi. the Internet, a local area network (LAN), a wireless local area network (wireless LAN), a wide area network (WAN), a telephone network, a personal area network (PAN), 3G, 4G, Long-Term Evolution (LET), a voice network or a combination of two or more thereof.

Hereunder, the invention will be described in detail by referring to the attached drawings. In describing the particular embodiments that will be described hereunder, various particulars are provided to describe the invention in detail and to enhance understanding of the invention. However, it will become apparent to readers who have enough knowledge to understand the art to which the invention pertains that the invention may be used without the particulars. In some cases, in describing the invention, detailed descriptions of the things that are well-known or are not closely related to the invention will be omitted if they are deemed to make the gist of the present invention unnecessarily vague.

In the following embodiments, like reference numerals refer to like elements for convenience's sake.

FIG. 1 is a view illustrating a two-channel based authentication system according to an embodiment of the present invention.

By referring to FIG. 1, a two-channel based authentication system according to an embodiment of the present invention may include a computer 10 of an authentication requester, an authentication server 20, a call processing server 30 and a telephone 40 of the authentication requester. These elements may communicate with each other through communication networks.

A call processing server 30 manages (stores, adds, deletes, corrects) a DB 20 including a list of lines available for communication so as to manages lines available for communication, and an authentication server 20 manages a temporary DB 50. When receiving a request for authentication from an authentication requester, the authentication server 20 creates a temporary DB 50 corresponding to the authentication requester, determines whether to authorize the request for authentication and then deletes the temporary DB 50 after determining whether to authorize the request for authentication. According to an embodiment, the temporary DB 50 is created on the basis of each authentication requester.

By referring to FIG. 1, a computer 10 of an authentication requester (hereinafter referred to as “computer 10”) includes computer processors (invisible), memory (invisible) and operating systems (invisible) and displays a website 11 provided by a web server (invisible) connected to a communication network.

The computer 10 has software and hardware (invisible) so as to receive the website 11 through communication with the web server (invisible) connected with the communication network.

The computer 10 denotes a device, capable of accessing the Internet and displaying a provided website, such as a desktop computer, a smartphone or a laptop.

In this specification, “authentication” may be a procedure necessary to log in to the website 11. In general, in order to log in to websites, users input their IDs and passwords and then, obtain authentication. However, according to the present invention, users may obtain authentication in a safe manner only by inputting their IDs or telephone numbers.

The computer 10 may input identification information (e.g. a user ID) of an authentication requester and may display an authentication-request screen including menus 13, 15 for requesting authentication.

In this embodiment, authentication requesters input their IDs on the authentication-request screen displayed by the computer 10 and select a login menu 15. Then, the computer 10 transmits the request for authentication to the authentication server 20. Herein, the request for authentication may include IDs or telephone numbers of the authentication requesters.

When receiving the request for authentication from the computer 10, the authentication server 20 stores in the temporary DB 50 the time when the authentication server 20 receives the request for authentication (hereinafter referred to as “the time of receiving the request for authentication”). The authentication server 20 associates “the time of receiving the request for authentication” with a “telephone number of the authentication requester” and stores “the time of receiving the request for authentication” and the “telephone number of the authentication requester” in the temporary DB 50.

The authentication server 20 may obtain a telephone number of the authentication requester with reference to a member DB (invisible)—a database in which the IDs and telephone numbers of members who subscribed to the website 11 are associated and stored. The member DB (invisible) may be managed by a web server (invisible) providing the website 11.

When receiving the request for authentication from the computer 10, the authentication server 20 selects a line number available for calling to transmit the line number to a telephone 40 of the authentication requester (herein after referred to as “telephone 40”). The telephone 40 calls at the transmitted line number.

The telephone 40 includes a computer processor (invisible), memory (invisible), an operating system (invisible), and a service program 41 capable of receiving the line number through the authentication server 20 and Internet communication.

The telephone 40 is capable of data communication with the authentication server 20 connected with Internet networks and is provided with software and hardware (invisible) capable of voice calls.

For instance, the telephone 40 may be a device such as a smartphone, a smart watch, a tablet PC or a PDA phone etc. Herein, the smart phone denotes a mobile phone functioning as a PC and providing advanced functions, the smart watch denotes a wrist watch having an embedded system and providing functions that are more advanced than those of an ordinary watch, the tablet PC denotes a mobile PC having a touchscreen as a main input device, and the PDA phone denotes a PDA (Personal Digital Assistant) provided with a mobile communication module.

The service program 41 installed on the telephone 40 is to perform at least some of the functions necessary to provide authentications services according to the present invention, and if there is a line number transmitted by the authentication server 20, the service program 41 pages a calling program (invisible) provided to the telephone 40 to make a call.

When paging the calling program (invisible), the service program 41 provides to the calling program the line number transmitted by the authentication server 20. Afterwards, the calling program calls at the line number provided by the service program 41.

The call processing server 30, for instance, may be an exchange device such as an Internet protocol private branch exchange (IP PBX) and may manage a plurality of telephone numbers.

The line number transmitted to the telephone 40 by the authentication server 20 may be any one of the telephone numbers managed by the call processing server 30.

When receiving a call from the telephone 40, the call processing server 30 transmits to the authentication server 20 the caller's telephone number (i.e. telephone number of the telephone 40).

The authentication server 20 may authorize the request (may determine to authorize the request), if the caller's telephone number transmitted by the call processing server 30 is the same as the telephone number of the authentication requester stored in the temporary DB 50 as a result of comparison between the caller's telephone number transmitted by the call processing server 30 and the telephone number of the authentication requester stored in the temporary DB 50. Further, the authentication server 20 may authorize the request for authentication only when the authentication server 20 receives the caller's telephone number transmitted by the call processing server 30 within a preset time from the “time of receiving the request for authentication” stored in the temporary DB 50.

When the authentication server 20 receives the caller's telephone number transmitted by the call processing server 30 after a preset time from the “time of receiving the request for authentication”, the authentication server 20 does not authorize the request for authentication (determines not to authorize the request for authentication), regardless of the result of comparison between the caller's telephone number transmitted by the call processing server 30 and the telephone number of the authentication requester stored in the temporary DB 50.

Hereunder, by respectively referring to FIGS. 2 to 7, more detailed embodiments of FIG. 1 will be described.

FIG. 2 is a view illustrating a two-channel based authentication system according to an embodiment of the present invention, and the two-channel based authentication system in FIG. 1 may be embodied to operate like the two-channel based authentication system in FIG. 2.

By referring to FIGS. 1 and 2, a computer 10 displays an authentication-request screen, and an authentication requester inputs on the authentication-request screen identification information of the authentication requester such as a user ID or a telephone number of the authentication requester, and then, the computer 10 makes a request for authentication 20 to an authentication server 20. The request for authentication transmitted to the authentication server 20 includes the identification information input by the authentication requester. The identification information of the authentication requester may be the user ID or telephone number of the authentication requester as described above.

When receiving the request for authentication from the computer 10, the authentication server 20 creates a temporary DB 50 corresponding to the authentication requester and associates the time of receiving the request for authentication from the computer 10 with the telephone number of the authentication requester to store the time of receiving the request for authentication from the computer 10 and the telephone number of the authentication requester in the temporary DB 50. The telephone number of the authentication requester is included in the request for authentication, or the authentication server 20 may obtain the telephone number, as described by referring to FIG. 1, if the telephone number of the authentication requester is not included in the request for authentication.

The authentication requester operates a service program installed on the authentication requester's telephone 40. The service program 41 displays an authentication-request screen for requesting authentication on the telephone 40, and the authentication requester requests authentication on the authentication-request screen. The telephone 40 requests the authentication server 20 to grant authentication when the authentication requester requests authentication on the authentication-request screen provided by the service program 41.

When receiving the request for authentication from the service program 41 installed on the telephone 40, the authentication server 20 randomly selects one of the plurality of line numbers available for calling managed by a call processing server 30. The selected line number, which is to be transmitted only to the telephone 40, may not be selected for another authentication requester unless a required period of time relapses. Herein, the required period of time, for instance, may last 15 seconds after the authentication server 20 receives the request for authentication from the computer 10. The required period of time of 15 seconds is given only as an example, and accordingly, another required period of time may be set.

The authentication server 20 transmits the selected line number to the service program 41 on the telephone 40.

When receiving the line number from the authentication server 20, the service program 41 calls a calling program (invisible) installed on the telephone 40 to provide the line number. The calling program (invisible) is a basic program provided to enable the telephone 40 to call.

The calling program (invisible) calls at the line number provided by the service program 41.

The line number provided by the authentication server 20 for the service program 41 is among the line numbers managed by the call processing server 30. When the calling program (invisible) calls at the line number provided by the service program 41, the call processing server 30 receives the call. The call processing server 30 immediately provides the caller's telephone number (herein, the telephone number of the telephone 40) to the authentication server 20.

The authentication server 20 determines to authorize the request for authentication and notifies the result of authentication to the computer 10 when comparing the caller's telephone number provided by the call processing server 30 with the telephone number of the authentication requester stored in the temporary DB 50 and determining the caller's telephone number provided by the call processing server 30 is the same as the telephone number of the authentication requester stored in the temporary DB 50.

Meanwhile, when receiving the caller's telephone number from the call processing server 30 after a preset time from the time of receiving the request for authentication from the computer 10, the authentication server 20 determines not to authorize the request for authentication regardless of the result of comparison between the caller's telephone number provided by the call processing server 30 and the telephone number of the authentication requester.

In this embodiment, the preset time may be stored in the temporary DB 50 or may be store in a separate storage device (a memory (invisible) provided to the authentication server 20 or a hard disc).

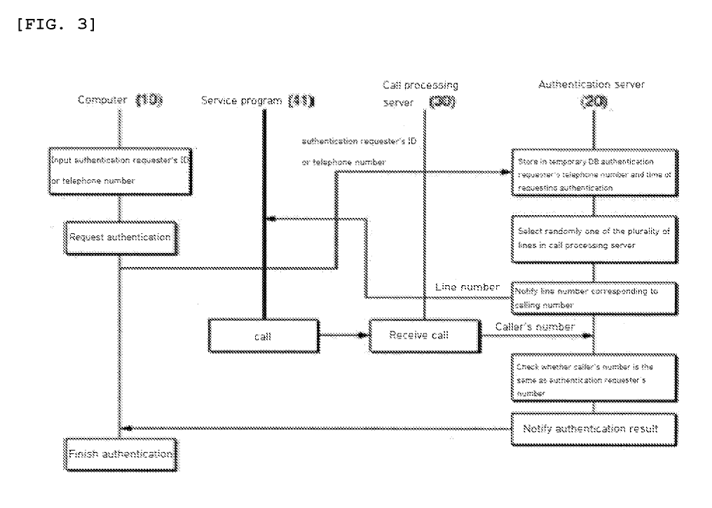

FIG. 3 is a view illustrating a two-channel based authentication system according to an embodiment of the present invention, and the two-channel based authentication system in FIG. 1 may be embodied to operate like the two-channel based authentication system in FIG. 3.

The embodiment in FIG. 3 differs from the embodiment in FIG. 2 in that the service program 41 of the embodiment in FIG. does not request the authentication server 20 to grant authentication. In describing the embodiment in FIG. 3, the difference between the embodiment in FIG. 2 and the embodiment in FIG. 3 will be described hereunder.

In describing the embodiment in FIG. 3 by referring to FIGS. 1 and 3, when receiving a request for authentication from the computer 10, the authentication server 20 creates a temporary DB 50 corresponding to the authentication requester and stores the time of receiving the request for authentication from the computer 10 and a telephone number of the authentication requester in the temporary DB 50. The telephone number of the authentication requester is included in the request for authentication, or the authentication server 20 may obtain the telephone number, as described by referring to FIG. 1, if the telephone number of the authentication requester is not included in the request for authentication. Further, when receiving the request for authentication from the computer 10, the authentication server randomly selects one of the plurality of line numbers available for calling managed by a call processing server 30. The authentication server 20 transmits the selected line number to the telephone 40. The other operations described in the embodiment in FIG. 3 are the same as those of the embodiment in FIG. 2 (see the descriptions of the embodiment in FIG. 2).

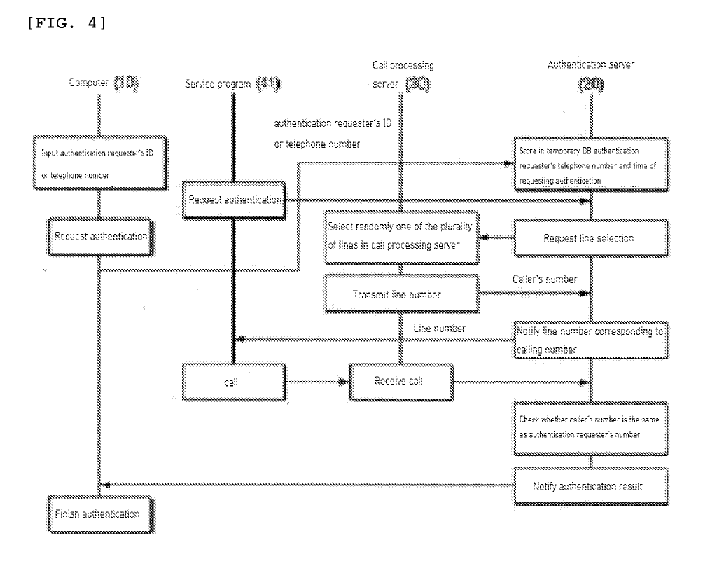

FIG. 4 is a view illustrating a two-channel based authentication system according to an embodiment of the present invention, and the two-channel based authentication system in FIG. 1 may be embodied to operate like the two-channel based authentication system in FIG. 4.

The embodiment in FIG. 4 differs from the embodiment in FIG. 2 in that the authentication server 20 of the embodiment in FIG. 4 does not directly select a line when the line transmitted to the telephone 40 is selected. Instead, the call processing server 30 selects any one of the line numbers available for calling to transmit the selected line number to the authentication server 20. The authentication server 20 transmits the line number selected by the call processing server 30 to the telephone 40.

In describing the embodiment in FIG. 4, the difference between the embodiment in FIG. 2 and the embodiment in FIG. 4 will be described hereunder.

In describing the embodiment in FIG. 4 by referring to FIGS. 1 and 4, when receiving a request for authentication from the computer 10, the authentication server 20 creates a temporary DB 50 corresponding to the authentication requester and associates the time of receiving the request for authentication from the computer 10 with a telephone number of the authentication requester to store the time of receiving the request for authentication from the computer 10 and the telephone number of the authentication requester in the temporary DB 50. When receiving the request for authentication from the computer 10 or from the telephone 40, the authentication server 20 requests the call processing server 30 to select a line available for calling. The call processing server 30 randomly selects one of the plurality of line numbers available for calling managed by the call processing server 30 to provide the line number to the authentication server 20. The authentication server 20 transmits the line number provided by the call processing server 30 to the telephone 40. The other operations described in the embodiment in FIG. 4 are the same as those of the embodiment in FIG. 2 (see the descriptions of the embodiment in FIG. 2).

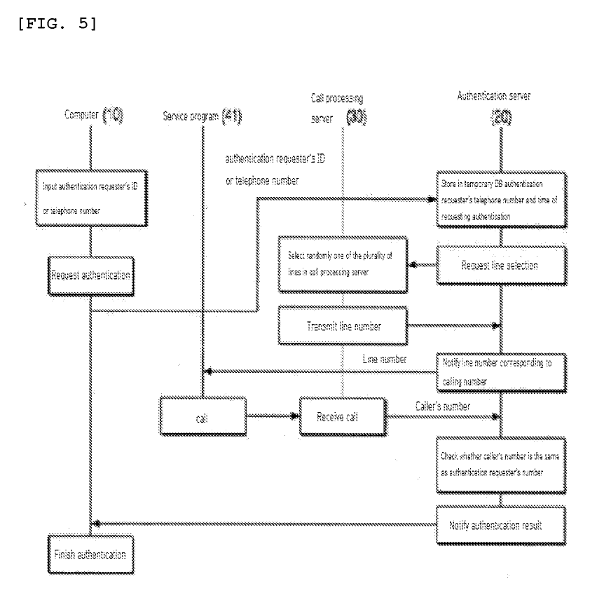

FIG. 5 is a view illustrating a two-channel based authentication system according to an embodiment of the present invention, and the two-channel based authentication system in FIG. 1 may be embodied to operate like the two-channel based authentication system in FIG. 5.

The embodiment in FIG. 5 differs from the embodiment in FIG. 2 in that the service program 41 of the embodiment in FIG. does not request the authentication server 20 to grant authentication and in that the authentication server 20 of the embodiment in FIG. 5 does not directly select a line number when the line number is selected. Instead, the call processing server 30 selects any one of the line numbers available for calling to provide the selected line number to the authentication server 20. The authentication server 20 transmits the line number selected by the call processing server 30 to the telephone 40.

In describing the embodiment in FIG. 5, the difference between the embodiment in FIG. 2 and the embodiment in FIG. 5 will be described hereunder.

In describing the embodiment in FIG. 5 by referring to FIGS. 1 and 5, when receiving a request for authentication from the computer 10, the authentication server 20 creates a temporary DB 50 corresponding to the authentication requester and associates the time of receiving the request for authentication from the computer 10 with a telephone number of the authentication requester to store the time of receiving the request for authentication from the computer 10 and the telephone number of the authentication requester in the temporary DB 50. When receiving the request for authentication from the computer 10, the authentication server 20 requests the call processing server 30 to select a line available for calling. The call processing server 30 randomly selects any one of the plurality of line numbers available for calling managed by the call processing server 30 to provide the line number to the authentication server 20. The authentication server 20 transmits the line number provided by the call processing server 30 to the telephone 40. The other operations described in the embodiment in FIG. 5 are the same as those of the embodiment in FIG. 2 (see the descriptions of the embodiment in FIG. 2).

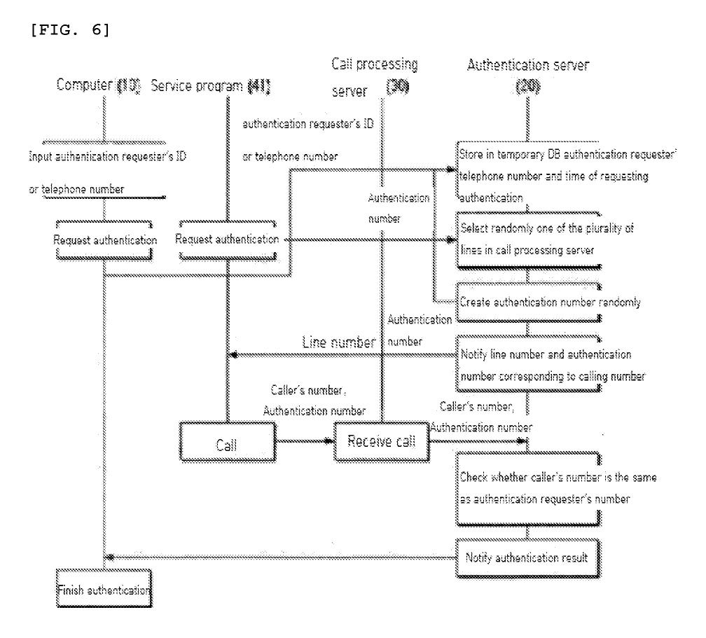

FIG. 6 is a view illustrating a two-channel based authentication system according to an embodiment of the present invention, and the two-channel based authentication system in FIG. 1 may be embodied to operate like the two-channel based authentication system in FIG. 6.

The embodiment in FIG. 6 differs from the embodiment in FIG. 2 in that the embodiment in FIG. 6 additionally uses an authentication number.

In describing the embodiment in FIG. 6, the difference between the embodiment in FIG. 2 and the embodiment in FIG. 6 will be described hereunder.

In describing the embodiment in FIG. 6 by referring to FIGS. 1 and 6, when receiving a request for authentication from the computer 10, the authentication server 20 creates a temporary DB 50 corresponding to the authentication requester and associates the time of receiving the request for authentication from the computer 10 with a telephone number of the authentication requester to store the time of receiving the request for authentication from the computer 10 and the telephone number of the authentication requester in the temporary DB 50.

When receiving the request for authentication from the computer 10 or from the telephone 40, the authentication server 20 randomly selects one of the plurality of line numbers available for calling. Further, when receiving the request for authentication from the computer 10 or from the telephone 40, the authentication server 20 creates an authentication number (a secret value unique to an authentication requester). The authentication number may be associated with the telephone number of the authentication requester and be stored together with the telephone number of the authentication requester in the temporary DB 50.

The authentication server 20 transmits the selected line number and the authentication number to the telephone 40. The telephone 40 calls at the line number and the authentication number. For instance, if the line number is 070-1234-0001, and the authentication number is 34, the telephone 40 calls at the number of 07012340001,34.

The call processing server 30 may know the telephone number (the caller's number) and the authentication number of the telephone 40 and transmits the caller's number and the authentication number to the authentication sever 20.

The authentication server 20 compares the caller's number with the telephone number of the authentication requester stored in the temporary DB 50 and compares the authentication number transmitted by the call processing server 30 with the authentication number stored in the temporary DB 50. The authentication server 20 determines to authorize the request for authentication, only when determining not only that the caller's number is the same as the telephone number of the authentication requester stored in the temporary DB 50 but also that the authentication number transmitted by the call processing server 30 is the same as the authentication number stored in the temporary DB 50. Meanwhile, when receiving the caller's telephone number from the call processing server 30 after a preset time from the time of receiving the request for authentication from the computer 10, the authentication server 20 determines not to authorize the request for authentication regardless of the results of the above-described comparison.

The other operations described in the embodiment in FIG. 6 are the same as those of the embodiment in FIG. 2 (see the descriptions of the embodiment in FIG. 2).

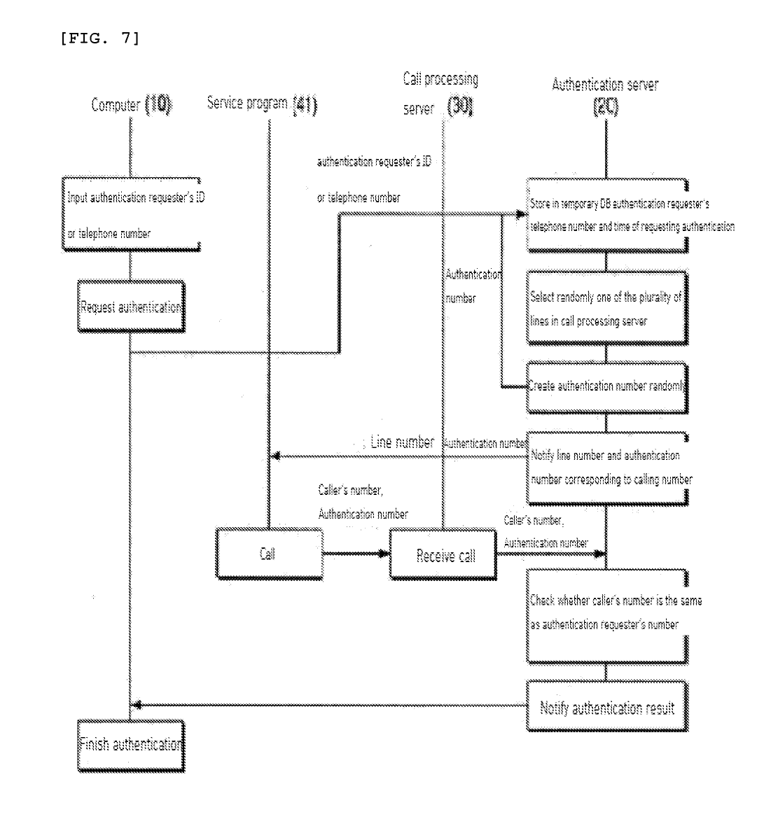

FIG. 7 is a view illustrating a two-channel based authentication system according to an embodiment of the present invention, and the two-channel based authentication system in FIG. 1 may be embodied to operate like the two-channel based authentication system in FIG. 7.

The embodiment in FIG. 7 differs from the embodiment in FIG. 2 in that a service program 41 of the embodiment in FIG. does not request the authentication server 20 to grant authentication and in that the embodiment in FIG. 7 uses an authentication number.

In describing the embodiment in FIG. 7, the difference between the embodiment in FIG. 2 and the embodiment in FIG. 7 will be described hereunder.

In describing the embodiment in FIG. 7 by referring to FIGS. 1 and 7, when receiving a request for authentication from the computer 10, the authentication server 20 creates a temporary DB 50 corresponding to the authentication requester and associates the time of receiving the request for authentication from the computer 10 with a telephone number of the authentication requester to store the time of receiving the request for authentication from the computer 10 and the telephone number of the authentication requester in the temporary DB 50.

When receiving the request for authentication from the computer 10, the authentication server 20 randomly selects one of the plurality of line numbers available for calling. Further, when receiving the request for authentication from the computer 10, the authentication server 20 creates an authentication number (a secret value unique to an authentication requester). The authentication number may be associated with the telephone number of the authentication requester and be stored together with the telephone number of the authentication requester in the temporary DB 50.

The authentication server 20 transmits the selected line number and the authentication number to the telephone 40. The telephone 40 calls at the line number and the authentication number.

The call processing server 30 may know the telephone number (a caller's number) and the authentication number of the telephone 40 and transmits the caller's number and the authentication number to the authentication sever 20.

The authentication server 20 compares the caller's number with the telephone number of the authentication requester stored in the temporary DB 50 and compares the authentication number transmitted by the call processing server 30 with the authentication number stored in the temporary DB 50. The authentication server 20 determines to authorize the request for authentication, only when determining not only that the caller's number is the same as the telephone number of the authentication requester stored in the temporary DB 50 but also that the authentication number transmitted by the call processing server 30 is the same as the authentication number stored in the temporary DB 50. Meanwhile, when receiving the caller's telephone number from the call processing server 30 after a preset time from the time of receiving the request for authentication from the computer 10, the authentication server 20 determines not to authorize the request for authentication regardless of the results of the above-described comparison.

The other operations described in the embodiment in FIG. 7 are the same as those of the embodiment in FIG. 2 (see the descriptions of the embodiment in FIG. 2).

A computer-implemented two-channel based authentication method which is implemented by a computer in a two-channel based authentication system according to an embodiment of the present invention will be described hereunder.

An authentication system, to which a computer-implemented two-channel based authentication method according to an embodiment of the present invention is applied, may be the two-channel based authentication system described by referring to FIG. 1. Under the assumption that a computer-implemented two-channel based authentication method according to an embodiment of the present invention is applied to the authentication system in FIG. 1, a two-channel based authentication method according to the embodiments of the present invention will be described hereunder.

A computer-implemented two-channel based authentication method according to an embodiment of the present invention includes: a displaying step in which a computer 10 of an authentication requester displays an authentication-request screen for requesting authentication—a screen that includes menus for inputting the authentication requester's identification information and for requesting authentication; a first transmitting step in which the computer 10 of the authentication requester transmits a request for authentication to an authentication server 20 when receiving the request for authentication from the authentication requester on the authentication-request screen; a storing step in which the authentication server 20 stores a telephone number of the authentication requester in a temporary DB 50 when receiving the request for authentication from the computer 10; a line number selecting step in which the authentication server 20 selects any one of line numbers available for calling; a second transmitting step in which the authentication server 20 transmits the line number selected in the line number selecting step to a telephone 40 of the authentication requester; a calling step in which the telephone 40 of the authentication requester calls at the line number transmitted by the authentication server 20; a third transmitting step in which a call processing server 30 transmits to the authentication server 20 a telephone number of a caller (i.e. the telephone 40 calling at the line number) when receiving a call at the line number; a comparing step in which the authentication server 20 compares the telephone number transmitted by the call processing server 30 with the telephone number of the authentication requester stored in the temporary DB 50; and a determining step in which the authentication server 20 determines to authorize the request for authentication from the computer 10 of the authentication requester, if the telephone number transmitted by the call processing server 30 is the same as the telephone number of the authentication requester stored in the temporary DB 50 as a result of the comparison in the comparing step.

The above-described computer-implemented two-channel based authentication method may further include a fourth transmitting step in which the telephone 40 of the authentication requester transmits the request for authentication to the authentication server 20. The authentication server 20 performs the step of selecting the line number when receiving the request for authentication from the telephone 40 or the computer 10 of the authentication requester. Herein, the fourth transmitting step may be performed before the first transmitting step.

In the above-described computer-implemented two-channel based authentication method, the authentication server 20 further includes and stores in the temporary DB 50 the time of receiving the request for authentication from the computer 10 of the authentication requester when receiving the request for authentication from the computer 10 of the authentication requester.

In the above-described computer-implemented two-channel based authentication method, when carrying out the determining step, the authentication server 20 determines not to authorize the request for authentication from the computer 10 of the authentication requester in the event that the call processing server 30 receives the call from the telephone 40 of the authentication requester or the authentication server 20 receives the caller's number from the call processing server 30 after a preset time from the time of receiving the request for authentication stored in the temporary DB 50.

In the above-described computer-implemented two-channel based authentication method, the request for authentication transmitted to the authentication server 20 by the telephone of the authentication requester includes displaying an authentication-request screen—a screen that includes menus for requesting authentication—installed on the telephone 40 of the authentication requester such that the telephone 40 of the authentication requester may request the authentication server 20 to grant authentication, and including an ID of a program requesting the authentication server 20 to grant authentication if a user makes a request for authentication on the menus.

In the above-described computer-implemented two-channel based authentication method, the line number selecting step may be a step in which the authentication server 20 selects any one of the line numbers available for calling out of lines managed by the call processing server 30 or a step in which the authentication server 20 requests the call processing server 30 to select a line number such that the call processing server 30 selects a line number.

The above-described computer-implemented two-channel based authentication method may further include a step in which the authentication server 20 creates an authentication number when receiving the request for authentication from the computer 10 of the authentication requester. The authentication server 20 performs the line number selecting step when receiving the request for authentication from the telephone 40 of the authentication requester. Further, the authentication server 20 transmits the selected line number together with the authentication number when performing the second transmitting step, and the telephone 40 of the authentication requester calls at a telephone number comprising the selected line number and the authentication number. The call processing server 30 transmits to the authentication server 20 the authentication number sent from a caller (the telephone 40 of the authentication requester) together with a telephone number of the caller when receiving a call at the selected line number and the authentication number and performing the third transmitting step. Further, in the comparing step, the authentication server 20 compares the telephone number transmitted by the call processing server 30 with the telephone number of the authentication requester stored in the temporary DB 50 and compares the authentication number created by the authentication server 20 with the authentication number transmitted by the call processing server 30. The authentication server 20, in the determining step, authorizes the request for authentication from the computer 10 of the authentication requester, if the telephone number transmitted by the call processing server 30 is the same as the telephone number of the authentication requester stored in the temporary DB 50, and the authentication number created by the authentication server 20 is the same as the authentication number transmitted by the call processing server 30, as a result of the comparison in the above-described comparing step.

1. A computer-implemented two-channel based authentication method which is implemented by a computer in a two-channel based authentication system comprising a computer of an authentication requester, a telephone of the authentication requester, an authentication server, and a call processing server, comprising:
a displaying step in which the computer of the authentication requester displays an authentication-request screen for requesting authentication—a screen that comprises menus for inputting the authentication requester's identification information and for requesting authentication;
a first transmitting step in which the computer of the authentication requester transmits a request for authentication to the authentication server when receiving the request for authentication from the authentication requester on the authentication-request screen;
a storing step in which the authentication server stores a telephone number of the authentication requester in a temporary DB when receiving the request for authentication;
a line number selecting step in which the authentication server selects any one of line numbers available for calling;
a second transmitting step in which the authentication server transmits the line number selected in the line number selecting step to the telephone of the authentication requester;
a calling step in which the telephone of the authentication requester calls at the line number transmitted by the authentication server;
a third transmitting step in which the call processing server transmits to the authentication server a telephone number of the telephone calling at the selected line number when receiving a call at the selected line number;
a comparing step in which the authentication server compares the telephone number transmitted by the call processing server with the telephone number of the authentication requester stored in the temporary DB; and
a determining step in which the authentication server determines to authorize the request for authentication from the computer of the authentication requester, if the telephone number transmitted by the call processing server is the same as the telephone number of the authentication requester stored in the temporary DB as a result of the comparison in the comparing step.

2. The computer-implemented two-channel based authentication method according to claim 1, further comprising:
a fourth transmitting step in which the telephone of the authentication requester transmits the request for authentication to the authentication server,
wherein the authentication server performs the line number selecting step when receiving the request for authentication from the telephone of the authentication requester.

3. The computer-implemented two-channel based authentication method according to claim 1, wherein the authentication server performs the line number selecting step when receiving the request for authentication from the computer of the authentication requester.

4. The computer-implemented two-channel based authentication method according to claim 2 or 3, wherein the authentication server further comprises and stores in the temporary DB the time of receiving the request for authentication from the computer of the authentication requester when receiving the request for authentication from the computer of the authentication requester.

5. The computer-implemented two-channel based authentication method according to claim 4, wherein the authentication server, when carrying out the determining step, determines not to authorize the request for authentication from the computer of the authentication requester in the event that the call processing server receives the call from the telephone of the authentication requester after a preset time from the time of receiving the request for authentication stored in the temporary DB or that the authentication server receives the caller's number from the call processing server after a preset time from the time of receiving the request for authentication stored in the temporary DB.

6. The computer-implemented two-channel based authentication method according to claim 5, wherein the request for authentication transmitted to the authentication server by the telephone of the authentication requester comprises displaying an authentication-request screen—a screen that comprises menus for requesting authentication—installed on the telephone of the authentication requester such that the telephone of the authentication requester may request the authentication server to grant authentication, and including an ID of a program requesting the authentication server to grant authentication if a user makes a request for authentication on the menus.

7. The computer-implemented two-channel based authentication method according to claim 2 or 3, wherein the line number selecting step comprises a step in which the authentication server selects any one of the line numbers available for calling out of lines managed by the call processing server or a step in which the authentication server requests the call processing server to select a line number such that the call processing server selects a line number.

8. The computer-implemented two-channel based authentication method according to claim 2 or 3, further comprising a step in which the authentication server creates an authentication number when receiving the request for authentication from the computer of the authentication requester,
wherein the authentication server performs the line number selecting step when receiving the request for authentication from the telephone of the authentication requester,
the authentication server transmits the given line number together with the authentication number when performing the second transmitting step, and the telephone of the authentication requester calls at a telephone number comprising the selected line number and the authentication number,
the call processing server, in the third transmitting step, transmits to the authentication server the authentication number together with a telephone number of the telephone calling at the selected line number when receiving a call at the selected line number,
the authentication server, in the comparing step, compares the telephone number transmitted by the call processing server with the telephone number of the authentication requester stored in the temporary DB and compares the authentication number created by the authentication server with the authentication number transmitted by the call processing server, and the authentication server, in the determining step, authorizes the request for authentication from the computer of the authentication requester, if the telephone number transmitted by the call processing server is the same as the telephone number of the authentication requester stored in the temporary DB, and the authentication number created by the authentication server 20 is the same as the authentication number transmitted by the call processing server, as a result of the comparison in the comparing step.

9. A two-channel based authentication system including a computer of an authentication requester, a telephone of the authentication requester, an authentication server, and a call processing server,
wherein the computer of the authentication requester displays an authentication-request screen for requesting authentication—a screen that comprises menus for inputting the authentication requester's identification information and for requesting authentication,
the computer of the authentication requester transmits a request for authentication to the authentication server when receiving the request for authentication from the authentication requester on the authentication-request screen,
the authentication server selects any one of line numbers available for calling and transmits the selected line number to the telephone of the authentication requester,
the telephone of the authentication requester calls at the line number transmitted by the authentication server,
the call processing server transmits to the authentication server a telephone number of the telephone calling at the selected line number when receiving a call at the selected line number, and
the authentication server compares the telephone number transmitted by the call processing server with the telephone number of the authentication requester and determines the telephone number transmitted by the call processing server is the same as the telephone number of the authentication requester to determine to authorize the request for authentication from the computer of the authentication requester.

10. The two-channel based authentication system according to claim 9, wherein the telephone of the authentication requester transmits the request for authentication to the authentication server, and the authentication server selects any one of line numbers available for calling when receiving the request for authentication from the telephone of the authentication requester.

11. A two-channel based authentication system according to claim 9, wherein the authentication server selects any one of line numbers available for calling when receiving the request for authentication from the computer of the authentication requester.

12. A two-channel based authentication system according to claim 10 or 11, wherein the authentication server determines not to authorize the request for authentication from the computer of the authentication requester in the event that the call processing server receives the call from the telephone of the authentication requester after a preset time from the time of receiving the request for authentication from the computer of the authentication requester or the authentication server receives the caller's number from the call processing server after a preset time from the time of receiving the request for authentication from the computer of the authentication requester.

13. The two-channel based authentication system according to claim 10 or 11,
wherein the authentication server creates an authentication number when receiving the request for authentication from the computer of the authentication requester,
the authentication server selects any one of line numbers available for calling when receiving the request for authentication from the telephone of the authentication requester,
the authentication server transmits to the telephone of the authentication requester the selected line number together with the authentication number, and the telephone of the authentication requester calls at a telephone number comprising the selected line number and the authentication number,
the call processing server transmits to the authentication server the authentication number together with a telephone number of the telephone calling at the selected line number when receiving a call at the selected line number, and
the authentication server compares the telephone number transmitted by the call processing server with the telephone number of the authentication requester stored in the temporary DB and compares the authentication number created by the authentication server with the authentication number transmitted by the call processing server, and the authentication server authorizes the request for authentication from the computer of the authentication requester, if the telephone number transmitted by the call processing server is the same as the telephone number of the authentication requester stored in the temporary DB, and the authentication number created by the authentication server is the same as the authentication number transmitted by the call processing server, as a result of the comparison.
